(19) United States
(12) Patent Application Publication
(10) Pub. No.: US 2024/0416998 A1
(43) Pub. Date: Dec. 19, 2024

(54) VEHICLE BODY STRUCTURE

(71) Applicant: HONDA MOTOR CO., LTD., Tokyo (JP)

(72) Inventors: Masayasu Yoshida, Wako-shi (JP); Satoru Kawabe, Wako-shi (JP); Hiroyo Miyanaga, Wako-shi (JP); Hisashi Suzuki, Wako-shi (JP)

(21) Appl. No.: 18/735,252

(22) Filed: Jun. 6, 2024

(30) Foreign Application Priority Data
Jun. 13, 2023 (JP) 2023-096859

(51) Int. Cl. B62D 21/15

(52) U.S. Cl. CPC B62D 21/152

(57) ABSTRACT

A vehicle body structure includes an upper panel, a lower panel, and a plurality of reinforcement members that extend in a vehicle forward-rearward direction. The plurality of reinforcement members each has a stiffness change region. The stiffness change region of a first reinforcement member that constitutes one of the plurality of reinforcement members is provided at a different position in a longitudinal direction from the stiffness change region of a second reinforcement member that constitutes one of the plurality of reinforcement members.

### CROSS-REFERENCE TO RELATED APPLICATION

Priority is claimed on Japanese Patent Application No. 2023-096859, filed on Jun. 13, 2023, the contents of which are incorporated herein by reference.

### BACKGROUND

### Field of the Invention

The present invention relates to a vehicle body structure.

### Background

In recent years, efforts have been made to provide access to sustainable transportation systems. In order to realize this, research and development for further improving traffic safety or convenience has been focused on through developments relating to vehicle body stiffness. For example, a vehicle body structure is known in which a bead (hereinafter, may be referred to as a fragile portion) that induces initial buckling is provided on a front end side of an upper frame, and a plurality of bulkheads are provided at intervals on a rear end side of the upper frame from the fragile portion. Each bulkhead is provided so as to be sandwiched by the upper frame. According to the vehicle body structure, when an impact load is input from a vehicle forward direction, it is possible to absorb the impact load by crushing the upper frame in a vehicle rearward direction (for example, refer to Japanese Unexamined Patent Application, First Publication No. H7-228267).

### SUMMARY

In the vehicle body stiffness, according to the vehicle body structure of the related art, when an impact load is input, the impact load is absorbed only by crushing the upper frame in the vehicle rearward direction. Therefore, when this configuration is applied to a member having a large area such as a floor panel (hereinafter, may be referred to as a panel), there is room for improvement with respect to an increase of the load absorption efficiency.

An aspect of the present invention aims to provide a vehicle body structure that can improve load absorption efficiency by a panel and contributes to the development of a sustainable transportation system.

(1) A vehicle body structure according to an aspect of the present invention includes: a panel that is provided on a vehicle lower part; and a plurality of reinforcement members that are provided on the panel and extend in a vehicle forward-rearward direction, wherein the plurality of reinforcement members each has a stiffness change region, and the stiffness change region of a first reinforcement member that constitutes one of the plurality of reinforcement members is provided at a different position in a longitudinal direction from the stiffness change region of a second reinforcement member that constitutes one of the plurality of reinforcement members.

The case where the panel is provided on a vehicle rearward side and the case where the panel is provided on a vehicle forward side are conceivable. For example, in the case where the panel is provided on the vehicle rearward side, an arrangement example is conceivable in which the first reinforcement member having the stiffness change region on the vehicle rearward side is arranged at the middle in a vehicle width direction, and the second reinforcement member having the stiffness change region on the vehicle forward side is arranged at right and left sides in the vehicle width direction.

In this arrangement, when an impact load is input from a vehicle rearward direction, the stiffness change region of the first reinforcement member and the stiffness change region of the second reinforcement member deform. Here, the stiffness change region of the first reinforcement member arranged at the middle in the vehicle width direction is provided at a different position at the vehicle rearward position from the stiffness change region of the second reinforcement member. Therefore, a load that deforms the panel to right and left outer sides in the vehicle width direction is transmitted to the panel.

Further, due to the input impact load, a load that deforms the panel in the vehicle forward-rearward direction is transmitted to the panel.

Accordingly, when the impact load is input from the vehicle rearward direction, the load that deforms the panel in the vehicle forward-rearward direction and to the right and left outer sides in the vehicle width direction can be transmitted to the panel. That is, the load can be distributed (transmitted) to the entire region of the panel having a large area.

Further, for example, in the case where the panel is provided on the vehicle rearward side, an arrangement example is conceivable in which the first reinforcement member having the stiffness change region on the vehicle rearward side is arranged at the right and left sides in the vehicle width direction, and the second reinforcement member having the stiffness change region on the vehicle forward side is arranged at the middle in the vehicle width direction.

In this arrangement, when an impact load is input from the vehicle rearward direction, the stiffness change region of the first reinforcement member and the stiffness change region of the second reinforcement member deform. Here, the stiffness change region of the first reinforcement member arranged at the right and left sides in the vehicle width direction is provided at a different position at the vehicle rearward position from the stiffness change region of the second reinforcement member. Therefore, a load that deforms the panel to right and left inner sides in the vehicle width direction is transmitted to the panel.

Further, due to the input impact load, a load that deforms the panel in the vehicle forward-rearward direction is transmitted to the panel.

Accordingly, when the impact load is input from the vehicle rearward direction, the load that deforms the panel in the vehicle forward-rearward direction and to the right and left inner sides in the vehicle width direction can be transmitted to the panel. That is, the load can be distributed to the entire region of the panel having a large area.

In this way, by distributing the load to the entire region of the panel, it is possible to induce deformation of the panel by the distributed load. Therefore, it is possible to suitably deform the entire region of the panel having a large area, and it is possible to improve the load absorption efficiency by the panel. Further, it is possible to contribute to the development of a sustainable transportation system.

Further, for example, when the panel is provided on the vehicle forward side, an impact load is input from a vehicle forward direction. Even in this case, when the impact load is input from the vehicle forward direction, it is possible to improve the load absorption efficiency by the panel similarly to the case where the panel is provided on the vehicle rearward side.

(2) In the aspect described above, a fragile portion formed in an entire region in a vehicle width direction of the panel may be provided on the panel. According to this configuration, when an impact load is input from the vehicle forward-rearward direction, it is possible to promote deformation in the vehicle forward-rearward direction of the panel by the fragile portion. Therefore, the load transmitted to the panel can be distributed to the entire region of the panel. Thereby, by the distributed load, it is possible to suitably deform the entire region of the panel.

(3) In the aspect described above, a plurality of fragile portions each being the fragile portion may be provided in the vehicle forward-rearward direction.

According to this configuration, when an impact load is input from the vehicle forward-rearward direction, it is possible to further promote deformation in the vehicle forward-rearward direction of the panel by the plurality of the fragile portions. Therefore, the load can be suitably transmitted to each stiffness change region in accordance with the deformation of the panel. Therefore, by the transmitted load, it is possible to further suitably deform the entire region of the panel.

(4) In the aspect described above, the plurality of reinforcement members may be provided symmetrically in a rightward-leftward direction with reference to the middle in the vehicle width direction.

According to this configuration, when the load is transmitted to each stiffness change region, by the deformation of the stiffness change region, it is possible to deform the panel in the vehicle forward-rearward direction and the vehicle width direction. Therefore, the entire region of the panel is suitably deformed, and it is possible to uniformly improve the load absorption efficiency of the panel with respect to the entire panel. Thereby, the impact load input from the vehicle forward direction or the vehicle rearward direction is sufficiently absorbed by the panel, and it is possible to prevent an impact to the inside of a vehicle room. (5) In the aspect described above, the number of the plurality of reinforcement members may be odd.

According to this configuration, one reinforcement member among the plurality of the reinforcement members can be provided at the middle in the vehicle width direction. Therefore, when the load is transmitted to the reinforcement member provided in the middle in the vehicle width direction, by the deformation of the stiffness change region in the middle in the vehicle width direction, the load that causes deformation to the right and left outer sides in the vehicle width direction can be further suitably distributed to the panel. Therefore, by the distributed load, it is possible to further suitably deform the entire region of the panel having a large area.

According to the aspect of the present invention, it is possible to improve the load absorption efficiency by the panel, and it is possible to contribute to the development of a sustainable transportation system.

### BRIEF DESCRIPTION OF THE DRAWINGS

FIG. 1 is a perspective view of a vehicle body structure when seen from a vehicle rearward leftward direction in an embodiment of the present invention.

FIG. 2 is a plan view showing a rear floor portion of the vehicle body structure in the embodiment of the present invention.

FIG. 3 is a plan view in which an upper panel is disassembled from a rear floor structure of the vehicle body structure in the embodiment of the present invention.

FIG. 4 is a cross-sectional view taken along a IV-IV line of FIG. 2.

FIG. 5 is a cross-sectional view taken along a V-V line of FIG. 2.

FIG. 6 is a cross-sectional view taken along a VI-VI line of FIG. 2.

FIG. 7 is a conceptual diagram showing transmission of an impact load that is input from a vehicle rearward direction to a panel structure in the embodiment of the present invention.

FIG. 8 is a conceptual diagram showing transmission of an impact load that is input from the vehicle rearward direction to a panel structure of a modification example in the embodiment of the present invention.

### DESCRIPTION OF EMBODIMENTS

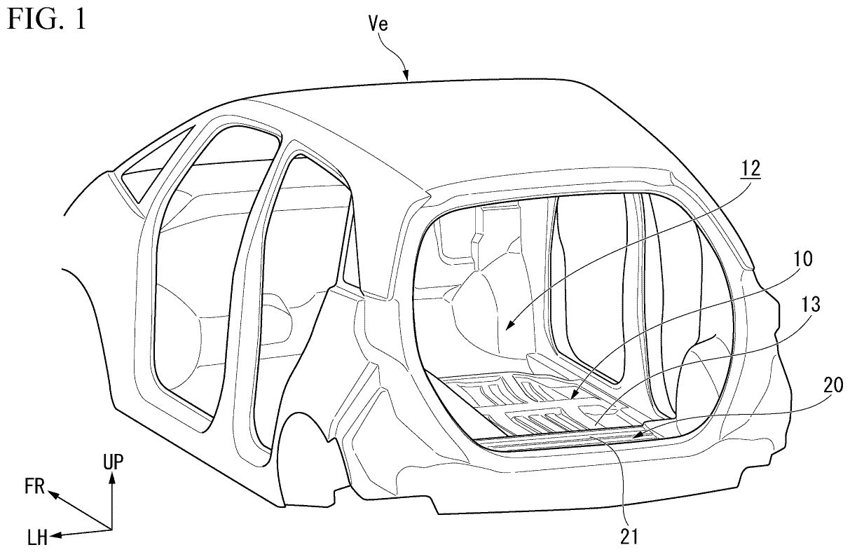

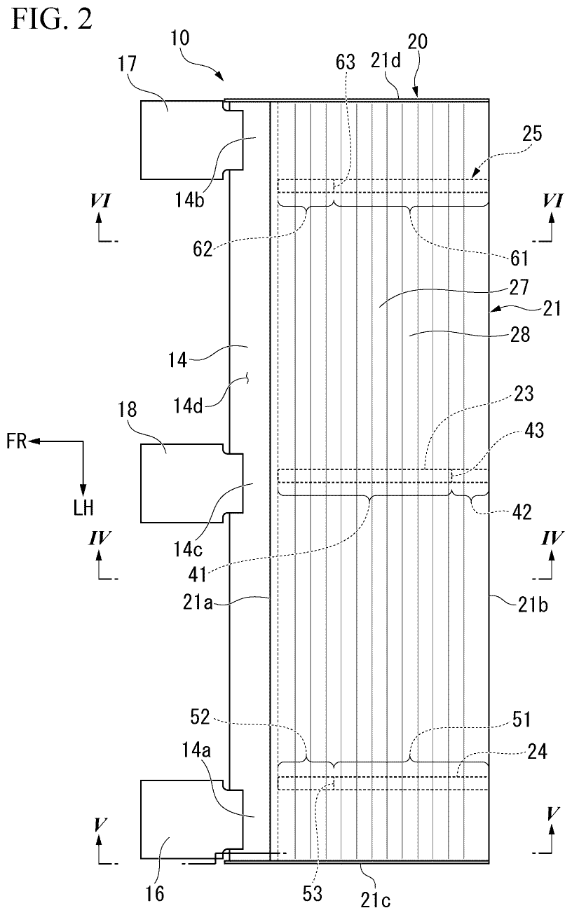

Hereinafter, a vehicle body structure according to an embodiment of the present invention will be described with reference to the drawings. In the drawings, an arrow FR indicates a forward direction of a vehicle, an arrow UP indicates an upward direction of the vehicle, and an arrow LH indicates a leftward direction of the vehicle. FIG. 1 is a perspective view of the vehicle body structure when seen from a vehicle rearward leftward direction. FIG. 2 is a plan view showing a rear floor portion of the vehicle body structure.

### Vehicle Body Structure

As shown in FIG. 1 and FIG. 2, a vehicle body structure Ve includes a rear floor structure 10 at a lower portion of a rear load room 12 in a vehicle rear part. The rear floor structure 10 includes, for example: a rear cross member 14 that extends in a vehicle width direction; a first side frame 16 and a second side frame 17 that are arranged on sides in the vehicle width direction, respectively; a center frame 18 that is arranged at the middle in the vehicle width direction; and a panel structure 20 that is provided on the rear cross member 14.

The rear cross member 14 extends from a left side portion of the vehicle to a right side portion in the vehicle rear part.

The first side frame 16 extends horizontally toward a vehicle forward direction from a left end portion 14a of the rear cross member 14.

The second side frame 17 extends horizontally toward the vehicle forward direction from a right end portion 14b of the rear cross member 14.

The center frame 18 extends horizontally toward the vehicle forward direction from a middle 14c in the vehicle width direction of the rear cross member 14. The rear cross member 14, the first side frame 16, the second side frame 17, and the center frame 18 are members having high stiffness that constitute a skeleton of the vehicle body structure Ve (specifically, the rear floor structure 10).

### Panel Structure

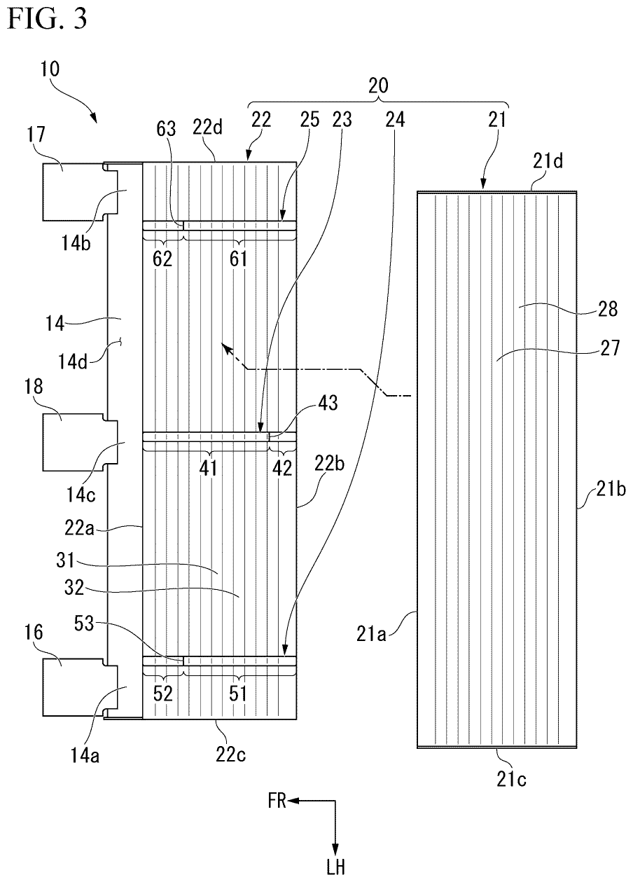

FIG. 3 is a plan view in which an upper panel is disassembled from the rear floor structure of the vehicle body structure.

As shown in FIG. 2 and FIG. 3, the panel structure 20 is provided on a rear lower portion (vehicle lower part) 13 (refer to FIG. 1) of the rear load room 12 by extending horizontally from the rear cross member 14 in a vehicle rearward direction. The panel structure 20 forms a floor portion of the vehicle rear part in the rear load room 12. The panel structure 20 includes an upper panel (panel) 21, a lower panel (panel) 22 arranged below the upper panel 21, and a plurality of reinforcement members 23, 24, 25 arranged between the upper panel 21 and the lower panel 22.

### Panel

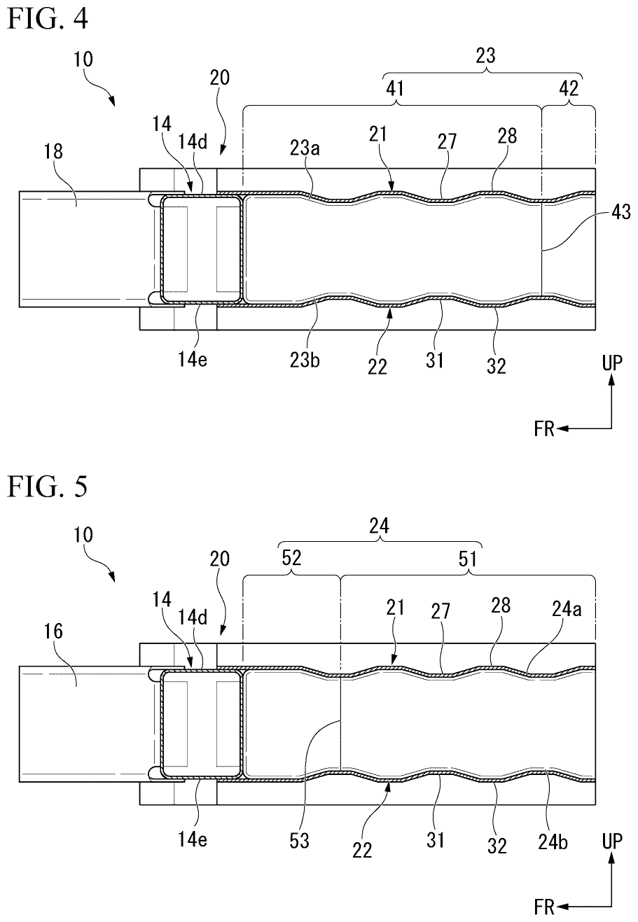

FIG. 4 is a cross-sectional view taken along a IV-IV line of FIG. 2.

As shown in FIG. 3 and FIG. 4, the upper panel 21 extends horizontally from an upper surface 14d of the rear cross member 14 in the vehicle rearward direction. The upper panel 21 is formed of a front side 21a, a rear side 21b, a left side 21c, and a right side 21d in a rectangular shape having a large area in plan view.

The upper panel 21 has a plurality of first recess portions 27 and a plurality of first protrusion portions 28 that are alternately provided continuously in a vehicle forward-rearward direction. The plurality of the first recess portions 27 are formed in a recess shape toward a vehicle downward direction when seen from a vehicle upward direction. The plurality of the first protrusion portions 28 are formed in a protrusion shape toward the vehicle upward direction when seen from the vehicle upward direction.

The plurality of the first recess portions 27 and the plurality of the first protrusion portions 28 are formed in a wave shape (that is, an uneven shape). The plurality of the first recess portions 27 and the plurality of the first protrusion portions 28 are continuously formed over the entire vehicle width direction in the upper panel 21. Therefore, the upper panel 21 is formed such that the stiffness is high against a load input from a vehicle upward-downward direction and a load input from the vehicle width direction by the plurality of the first recess portions 27 and the plurality of the first protrusion portions 28.

The first recess portion 27 forms a fragile portion in the upper panel 21. Hereinafter, the first recess portion 27 may be referred to as a “first fragile portion 27”. That is, the first fragile portion 27 is continuously formed over the entire vehicle width direction in the upper panel 21. A plurality of the first fragile portions 27 are provided in the vehicle forward-rearward direction. The plurality of the first fragile portions 27 are formed, for example, to be appropriately deformable (plastically deformable) by an impact load F1 input from the vehicle rearward direction.

The embodiment is described using an example in which the first fragile portion 27 is continuously formed over the entire upper panel 21; however, the embodiment is not limited thereto. As another example, the first fragile portion 27 may be discontinuously formed in a form in which part of the first fragile portion 27 is missing such as a stitch form of a sewing machine.

The lower panel 22 is formed similarly to the upper panel 21. That is, the lower panel 22 extends horizontally from a lower surface 14e of the rear cross member 14 in the vehicle rearward direction. The lower panel 22 is formed of a front side 22a, a rear side 22b, a left side 22c, and a right side 22d in a rectangular shape having a large area in plan view. The lower panel 22 has a plurality of second recess portions 31 and a plurality of second protrusion portions 32 that are alternately provided continuously in the vehicle forward-rearward direction. The plurality of the second recess portions 31 are formed in a recess shape toward the vehicle upward direction when seen from the vehicle downward direction. The plurality of the second protrusion portions 32 are formed in a protrusion shape toward the vehicle downward direction when seen from the vehicle downward direction.

The plurality of the second recess portions 31 and the plurality of the second protrusion portions 32 are formed in a wave shape (that is, an uneven shape). The plurality of the second recess portions 31 and the plurality of the second protrusion portions 32 are continuously formed over the entire vehicle width direction in the lower panel 22. Therefore, the lower panel 22 is formed such that the stiffness is high against a load input from the vehicle upward-downward direction and a load input from the vehicle width direction by the plurality of the second recess portions 31 and the plurality of the second protrusion portions 32.

The second recess portion 31 forms a fragile portion in the lower panel 22. Hereinafter, the second recess portion 31 may be referred to as a “second fragile portion 31”. That is, the second fragile portion 31 is continuously formed over the entire vehicle width direction in the lower panel 22. A plurality of second fragile portions 31 are provided in the vehicle forward-rearward direction. The plurality of the second fragile portions 31 are formed, for example, to be appropriately deformable (plastically deformable) by the impact load F1 input from the vehicle rearward direction. The plurality of the second fragile portions 31 are arranged at positions that face the plurality of the first fragile portions 27 in the upward-downward direction.

The embodiment is described using an example in which the second fragile portion 31 is continuously formed over the entire lower panel 22; however, the embodiment is not limited thereto. As another example, the second fragile portion 31 may be discontinuously formed in a form in which part of the second fragile portion 31 is missing such as a stitch form of a sewing machine.

Further, the present embodiment is described using an example in which the first fragile portion 27 and the second fragile portion 31 are formed along the vehicle width direction. However, the present invention is not limited thereto, and the first fragile portion 27 and the second fragile portion 31 may be inclined in the vehicle forward-rearward direction relative to the vehicle width direction.

### Reinforcement Member

The plurality of the reinforcement members 23, 24, 25 extend in the vehicle forward-rearward direction. Specifically, the plurality of the reinforcement members 23, 24, 25 extend toward the vehicle rearward direction from front ends (that is, the rear cross member 14) of the upper panel 21 and the lower panel 22 to rear ends of the upper panel 21 and the lower panel 22. The plurality of the reinforcement members 23, 24, 25 are formed, for example, of a plate material and are arranged toward the vehicle upward-downward direction.

The plurality of the reinforcement members 23, 24, 25 are bulkheads (partition walls) that partition a space between the upper panel 21 and the lower panel 22. The upper panel 21 and the lower panel 22 are reinforced by the plurality of the reinforcement members 23, 24, 25 by the plurality of the reinforcement members 23, 24, 25 being interposed between the upper panel 21 and the lower panel 22. Thereby, the stiffness of the panel structure 20 is ensured. The plurality of the reinforcement members 23, 24, 25 have a plurality of stiffness change regions 43, 53, 63 (described later), respectively.

For example, an odd number of the plurality of the reinforcement members 23, 24, 25 are provided. Specifically, one of the plurality of the reinforcement members 23, 24, 25 is constituted as a first reinforcement member, and the members other than the first reinforcement member are distinguished as a second reinforcement member. The difference between the first reinforcement member and the second reinforcement member will be described later. The present embodiment is described using an example in which the plurality of the reinforcement members 23, 24, 25 are a first reinforcement member 23 and second reinforcement members 24, 25.

That is, the plurality of the reinforcement members 23, 24, 25 include one first reinforcement member 23 and two second reinforcement members 24, 25. The present embodiment is described using an example in which the number of the plurality of the reinforcement members 23, 24, 25 is odd; however, the number of the plurality of the reinforcement members may be even. The number of the plurality of the reinforcement members is not limited to three and can be arbitrarily selected.

The one first reinforcement member 23 is provided at the middle in the vehicle width direction. Further, each of the two second reinforcement members 24, 25 is provided on each of right and left sides in the vehicle width direction. Specifically, the second reinforcement member 24 is provided at the left side in the vehicle width direction. The second reinforcement member 25 is provided at the right side in the vehicle width direction. That is, the plurality of the reinforcement members 23, 24, 25 are provided symmetrically in a rightward-leftward direction with reference to the middle in the vehicle width direction. In other words, the two second reinforcement members 24, 25 are provided at symmetrical positions in the rightward-leftward direction about the one first reinforcement member 23.

Hereinafter, for ease of understanding of the configuration, the second reinforcement member 25 provided at the right side in the vehicle width direction of the two second reinforcement members 24, 25 is described, for convenience, as a third reinforcement member 25.

The first reinforcement member 23 is provided at a vehicle rearward position further than the center frame 18 at the middle in the vehicle width direction. For example, an upper side 23a is bent in the vehicle width direction, and the first reinforcement member 23 is formed in an uneven shape (wave shape) along a lower surface (vehicle lower surface) of the upper panel 21. The upper side 23a of the first reinforcement member 23 is provided, for example, by being connected to the lower surface of the upper panel 21.

For example, a lower side 23b is bent in the vehicle width direction, and the first reinforcement member 23 is formed in an uneven shape (wave shape) along an upper surface (vehicle upper surface) of the lower panel 22. The lower side 23b of the first reinforcement member 23 is provided, for example, by being connected to the upper surface of the lower panel 22.

The first reinforcement member 23 includes a first reinforcement main body 41, a first thin portion 42 connected to a vehicle rear portion of the first reinforcement main body 41, and a first stiffness change region (stiffness change region) 43 formed at a boundary between the first reinforcement main body 41 and the first thin portion 42. The first thin portion 42 is formed such that a plate thickness is smaller than that of the first reinforcement main body 41. As a result, the first stiffness change region 43 is formed at the boundary between the first reinforcement main body 41 and the first thin portion 42. The first stiffness change region 43 is a suitably deformable portion by concentrating a stress when a load is input from a longitudinal direction (that is, the vehicle forward-rearward direction) to the first reinforcement member 23.

FIG. 5 is a cross-sectional view taken along a V-V line of FIG. 2.

As shown in FIG. 3 and FIG. 5, the second reinforcement member 24 is provided substantially at a vehicle rearward position further than the first side frame 16 at the left side in the vehicle width direction relative to the first reinforcement member 23. For example, an upper side 24a is bent in the vehicle width direction, and the second reinforcement member 24 is formed in an uneven shape (wave shape) along the lower surface of the upper panel 21. The upper side 24a of the second reinforcement member 24 is provided, for example, by being connected to the lower surface of the upper panel 21.

For example, a lower side 24b is bent in the vehicle width direction, and the second reinforcement member 24 is formed in an uneven shape (wave shape) along the upper surface of the lower panel 22. The lower side 24b of the second reinforcement member 24 is provided, for example, by being connected to the upper surface of the lower panel 22.

The second reinforcement member 24 includes a second reinforcement main body 51, a second thin portion 52 connected to a vehicle front portion of the second reinforcement main body 51, and a second stiffness change region (stiffness change region) 53 formed at a boundary between the second reinforcement main body 51 and the second thin portion 52. The second thin portion 52 is formed such that a plate thickness is smaller than that of the second reinforcement main body 51. Therefore, the second stiffness change region 53 is formed at the boundary between the second reinforcement main body 51 and the second thin portion 52. The second stiffness change region 53 is a suitably deformable portion by concentrating a stress when a load is input from a longitudinal direction (that is, the vehicle forward-rearward direction) to the second reinforcement member 24.

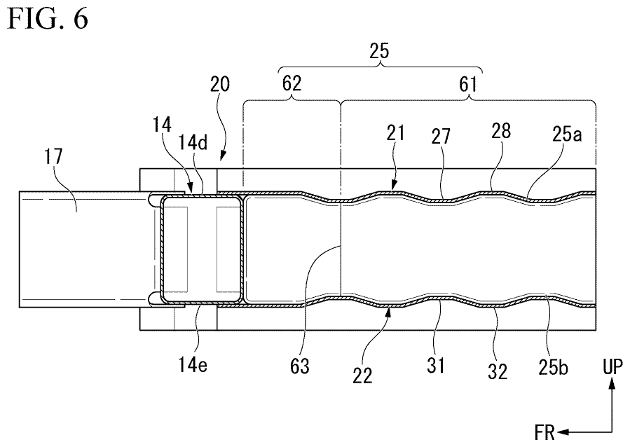

FIG. 6 is a cross-sectional view taken along a VI-VI line of FIG. 2.

As shown in FIG. 3 and FIG. 6, the third reinforcement member 25 is provided substantially at a vehicle rearward position further than the second side frame 17 at the right side in the vehicle width direction relative to the first reinforcement member 23. For example, an upper side 25a is bent in the vehicle width direction, and the third reinforcement member 25 is formed in an uneven shape (wave shape) along the lower surface of the upper panel 21. The upper side 25a of the third reinforcement member 25 is provided, for example, by being connected to the lower surface of the upper panel 21.

For example, a lower side 25b is bent in the vehicle width direction, and the third reinforcement member 25 is formed in an uneven shape (wave shape) along the upper surface of the lower panel 22. The lower side 25b of the third reinforcement member 25 is provided, for example, by being connected to the upper surface of the lower panel 22.

The third reinforcement member 25 is formed substantially similarly to the second reinforcement member 24. The third reinforcement member 25 includes a third reinforcement main body 61, a third thin portion 62 connected to a vehicle front portion of the third reinforcement main body 61, and a third stiffness change region (stiffness change region) 63 formed at a boundary between the third reinforcement main body 61 and the third thin portion 62. The third thin portion 62 is formed such that a plate thickness is smaller than that of the third reinforcement main body 61. Therefore, the third stiffness change region 63 is formed at the boundary between the third reinforcement main body 61 and the third thin portion 62.

The second stiffness change region 53 and the third stiffness change region 63 are provided at the same position in the vehicle forward-rearward direction. Further, the second stiffness change region 53 and the third stiffness change region 63 are provided in a vehicle forward direction relative to the first stiffness change region 43.

In this way, the first stiffness change region 43 is provided at a different position in a longitudinal direction from the second stiffness change region 53 and the third stiffness change region 63. The longitudinal direction refers to a longitudinal direction of the first reinforcement member 23, the second reinforcement member 24, and the third reinforcement member 25. That is, the first stiffness change region 43 is provided at a different position in the vehicle forward-rearward direction (in the embodiment, a vehicle rearward direction) from the second stiffness change region 53 and the third stiffness change region 63.

The present embodiment is described using an example in which the second stiffness change region 53 and the third stiffness change region 63 are provided at the same position in the vehicle forward-rearward direction; however, the embodiment is not limited thereto. As another example, the second stiffness change region 53 and the third stiffness change region 63 may be provided at a different position from each other in the vehicle forward-rearward direction. That is, all of the stiffness change regions of the first stiffness change region 43, the second stiffness change region 53, and the third stiffness change region 63 may be provided at a different position from one another in the vehicle forward-rearward direction.

The present embodiment is described using an example in which the stiffness change region is formed such that the plate thickness is different between the reinforcement main body and the thin portion; however, the embodiment is not limited thereto. As another example, a recess portion, an opening portion, or the like may be formed as the stiffness change region at the boundary between the reinforcement main body and the thin portion. For example, a material of the reinforcement main body may be differentiated from a material of the thin portion, and the stiffness change region may be formed at the boundary.

The present embodiment is described using an example in which the upper sides 23a to 25a of the plurality of the reinforcement members 23 to 25 are provided on the lower surface of the upper panel 21, and the lower sides 23b to 25b of the plurality of the reinforcement members 23 to 25 are provided on the upper surface of the lower panel 22;

however, the embodiment is not limited thereto. As another example, only the upper sides 23a to 25a of the plurality of the reinforcement members 23 to 25 may be provided on the lower surface of the upper panel 21, or only the lower sides 23b to 25b of the plurality of the reinforcement members 23 to 25 may be provided on the upper surface of the lower panel 22.

The present embodiment is described using an example in which the upper sides 23a to 25a of the plurality of the reinforcement members 23 to 25 are formed in an uneven shape, and the lower sides 23b to 25b of the plurality of the reinforcement members 23 to 25 are formed in an uneven shape; however, the embodiment is not limited thereto. As another example, the upper sides 23a to 25a and the lower sides 23b to 25b of the plurality of the reinforcement members 23 to 25 may be linearly extended in the vehicle forward-rearward direction. In this case, for example, the plurality of the upper sides 23a to 25a are provided on the plurality of the first fragile portions 27, and the plurality of the lower sides 23b to 25b are provided on the plurality of the second fragile portions 31.

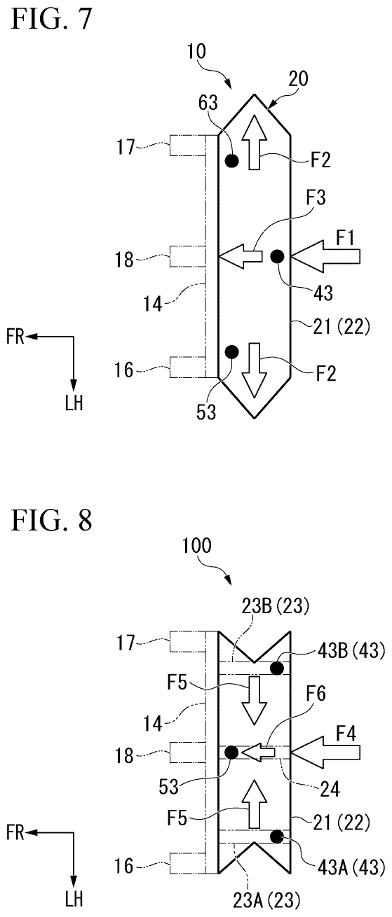

The present embodiment is described using an example in which the plurality of the reinforcement members 23 to 25 are formed of a plate material; however, the embodiment is not limited thereto. As another example, the plurality of the reinforcement members 23 to 25 may be formed in a hollow rectangular cross-section. Next, an example in which, when an impact load F1 is input to the panel structure 20 of the vehicle body structure Ve from the vehicle rearward direction, the input impact load F1 is absorbed by the panel structure 20 is described with reference to FIG. 2, FIG. 3, and FIG. 7.

FIG. 7 is a conceptual diagram showing transmission of an impact load that is input from the vehicle rearward direction to the panel structure.

As shown in FIG. 2, FIG. 3, and FIG. 7 and as described above, the panel structure 20 is provided at the vehicle rearward side. In the panel structure 20, the first reinforcement member 23 having the first stiffness change region 43 on the vehicle rearward side is arranged at the middle in the vehicle width direction. The second reinforcement member 24 having the second stiffness change region 53 on the vehicle forward side is arranged at the left side in the vehicle width direction. Additionally, the third reinforcement member 25 having the third stiffness change region 63 on the vehicle forward side is arranged at the right side in the vehicle width direction.

The impact load F1 is input from the vehicle rearward direction to the panel structure 20. In this case, the first stiffness change region 43 of the first reinforcement member 23, the second stiffness change region 53 of the second reinforcement member 24, and the third stiffness change region 63 of the third reinforcement member 25 are deformed by the input impact load F1.

Here, the first stiffness change region 43 at the middle in the vehicle width direction is provided at a different position at the vehicle rearward position from the second stiffness change region 53 at the left side in the vehicle width direction and the third stiffness change region 63 at the right side in the vehicle width direction. Therefore, a load F2 that deforms the upper panel 21 and the lower panel 22 to right and left outer sides in the vehicle width direction is transmitted to the upper panel 21 and the lower panel 22.

Further, due to the input impact load F1, a load F3 that deforms the upper panel 21 and the lower panel 22 in the vehicle forward-rearward direction (specifically, the vehicle forward direction) is transmitted to the upper panel 21 and the lower panel 22.

Therefore, when the impact load F1 is input to the panel structure 20, the load F2 that deforms the upper panel 21 and the lower panel 22 to the right and left outer sides in the vehicle width direction and the load F3 that deforms the upper panel 21 and the lower panel 22 in the vehicle forward-rearward direction can be transmitted to the upper panel 21 and the lower panel 22. That is, the load can be distributed (transmitted) to the entire region of the upper panel 21 and the lower panel 22 having a large area. Thereby, it is possible to induce deformation of the upper panel 21 and the lower panel 22 by the distributed load and suitably deform the entire region of the upper panel 21 and the lower panel 22 having a large area.

As described above, according to the panel structure 20 of the vehicle body structure Ve, it is possible to suitably deform the entire area of the upper panel 21 and the lower panel 22 having a large area. Thereby, the impact load F1 input to the panel structure 20 from the vehicle rearward direction can be sufficiently absorbed by the upper panel 21 and the lower panel 22, and it is possible to improve the load absorption efficiency. Further, it is possible to contribute to the development of a sustainable transportation system.

The first fragile portion 27 is provided on the upper panel 21, and the second fragile portion 31 is provided on the lower panel 22.

Therefore, for example, when the impact load F1 is input from the vehicle rearward direction, it is possible to promote deformation in the vehicle forward-rearward direction of the upper panel 21 by the first fragile portion 27. Similarly, it is possible to promote deformation in the vehicle forward-rearward direction of the lower panel 22 by the second fragile portion 31.

Thereby, the load transmitted to the upper panel 21 and the lower panel 22 can be distributed to the entire region of the upper panel 21 and the lower panel 22. Accordingly, by the distributed load, it is possible to further suitably deform the entire region of the upper panel 21 and the lower panel 22.

Additionally, the plurality of the first fragile portions 27 are provided in the vehicle forward-rearward direction, and the plurality of the second fragile portions 31 are provided in the vehicle forward-rearward direction. Therefore, when the impact load F1 is input from the vehicle rearward direction, it is possible to further promote deformation in the vehicle forward-rearward direction of the upper panel 21 by the plurality of the first fragile portions 27. Similarly, it is possible to further promote deformation in the vehicle forward-rearward direction of the lower panel 22 by the plurality of the second fragile portions 31.

Thereby, the load can be suitably transmitted to the first stiffness change region 43, the second stiffness change region 53, and the third stiffness change region 63 in accordance with the deformation in the vehicle forward-rearward direction of the upper panel 21 and the lower panel 22. Accordingly, by the transmitted load, it is possible to further suitably deform the entire region of the upper panel 21 and the lower panel 22.

The plurality of the reinforcement members (specifically, the first reinforcement member 23, the second reinforcement member 24, and the third reinforcement member 25) are provided symmetrically in the rightward-leftward direction with reference to the middle in the vehicle width direction. The first stiffness change region 43 is provided at a different position at the vehicle rearward position from the second stiffness change region 53 and the third stiffness change region 63. Therefore, by deforming the first stiffness change region 43, the second stiffness change region 53, and the third stiffness change region 63 by the load, it is possible to deform the upper panel 21 and the lower panel 22 in the vehicle forward-rearward direction and the vehicle width direction.

Accordingly, the entire region of the upper panel 21 and the lower panel 22 is suitably deformed, and it is possible to uniformly improve the load absorption efficiency of each panel 21, 22 with respect to the whole of the upper panel 21 and the lower panel 22. Therefore, the impact load F1 input from the vehicle rearward direction to the panel structure 20 can be sufficiently absorbed, and it is possible to prevent an impact to the inside of a vehicle room by the impact load F1.

Further, the number of the plurality of the reinforcement members (specifically, the first reinforcement member 23, the second reinforcement member 24, and the third reinforcement member 25) is odd. Therefore, the first stiffness change region 43 can be arranged at the middle in the width direction, and the first stiffness change region 43 can be provided at a different position at the vehicle rearward position from the second stiffness change region 53 and the third stiffness change region 63. Thereby, by deforming the first stiffness change region 43 at the middle in the width direction by the load, the load that causes deformation to the right and left outer sides in the vehicle width direction can be further suitably distributed to the upper panel 21 and the lower panel 22. Accordingly, by the distributed load, it is possible to further suitably deform the entire region of the upper panel 21 and the lower panel 22 having a large area.

### Modification Example

Next, with reference to FIG. 8, an example in which an impact load is input from a vehicle rearward direction to a panel structure 100 according to a modification example of the present embodiment is described. In the panel structure 100 of the modification example, the same and similar members as those of the embodiment described above are denoted by the same reference numerals, and a detailed description thereof is omitted.

FIG. 8 is a conceptual diagram showing transmission of an impact load that is input from the vehicle rearward direction to the panel structure of the modification example.

As shown in FIG. 8, in the panel structure 100 of the modification example, the upper panel 21 and the lower panel 22 are provided at a vehicle rearward side. The first reinforcement member 23 is arranged on the right side and the left side in the vehicle width direction. The first reinforcement member 23 has a first stiffness change region 43 arranged at a vehicle rearward position. The second reinforcement member 24 is arranged at the middle in the vehicle width direction. The second reinforcement member 24 has a second stiffness change region 53 arranged at a vehicle forward position.

Hereinafter, the first reinforcement member 23 and the first stiffness change region 43 that are arranged at the left side in the vehicle width direction are described as a first reinforcement member 23A and a first stiffness change region 43A. Further, the first reinforcement member 23 and the first stiffness change region 43 that are arranged at the right side in the vehicle width direction are described as a first reinforcement member 23B and a first stiffness change region 43B.

An impact load F4 is input to the panel structure 100 from the vehicle rearward direction. In this case, the first stiffness change region 43A of the first reinforcement member 23A provided at the left side in the vehicle width direction, the first stiffness change region 43B of the first reinforcement member 23B provided at the right side in the vehicle width direction, and the second stiffness change region 53 of the second reinforcement member 24 are deformed.

Here, the first stiffness change region 43A at the left side in the vehicle width direction and the first stiffness change region 43B at the right side in the vehicle width direction are provided at a different position at the vehicle rearward position from the second stiffness change region 53 at the middle in the vehicle width direction. Therefore, a load F5 that deforms the upper panel 21 and the lower panel 22 to right and left inner sides in the vehicle width direction is transmitted to the upper panel 21 and the lower panel 22.

Further, due to the input impact load F4, a load F6 that deforms the upper panel 21 and the lower panel 22 in the vehicle forward-rearward direction (specifically, the vehicle forward direction) is transmitted to the upper panel 21 and the lower panel 22. Therefore, when the impact load F4 is input to the panel structure 100, the load

F5 that deforms the upper panel 21 and the lower panel 22 to the right and left inner sides in the vehicle width direction and the load F6 that deforms the upper panel 21 and the lower panel 22 in the vehicle forward-rearward direction can be transmitted to the upper panel 21 and the lower panel 22. That is, the load can be distributed (transmitted) to the entire region of the upper panel 21 and the lower panel 22 having a large area. Thereby, it is possible to induce deformation of the upper panel 21 and the lower panel 22 by the distributed load and suitably deform the entire region of the upper panel 21 and the lower panel 22 having a large area.

As described above, according to the panel structure 100 of the modification example of the embodiment, it is possible to suitably deform the entire area of the upper panel 21 and the lower panel 22 having a large area. Thereby, the impact load F4 input to the panel structure 100 from the vehicle rearward direction can be sufficiently absorbed by the upper panel 21 and the lower panel 22, and it is possible to improve the load absorption efficiency. Further, it is possible to contribute to the development of a sustainable transportation system.

Further, according to the panel structure 100 of the modification example, it is possible to obtain actions and effects similar to those of the panel structure 20 of the embodiment.

Examples in which the panel structure 20 of the present embodiment and the panel structure 100 of the modification example are provided at the vehicle rear part have been described; however, the embodiment is not limited thereto. As another example, the panel structure 20 and the panel structure 100 may be provided at a vehicle front part.

When the panel structure 20 and the panel structure 100 are provided at the vehicle front part, for example, an impact load is input to the panel structure 20 and the panel structure 100 from a vehicle forward direction. Even in this case, similarly to the panel structure 20 of the embodiment and the panel structure 100 of the modification example, it is possible to improve the load absorption efficiency by the upper panel 21 and the lower panel 22. Further, it is possible to contribute to the development of a sustainable transportation system.

Further, even in the case where the panel structure 20 and the panel structure 100 are provided at the vehicle front part, it is possible to obtain actions and effects similar to those of the embodiment and the modification example.

The technical scope of the present invention is not limited to the embodiments described above, and various modifications can be added without departing from the scope of the present invention.

The components in the embodiments described above can be appropriately replaced by known components without departing from the scope of the present invention, and the modification examples described above can be appropriately combined.

What is claimed is:

1. A vehicle body structure, comprising:
a panel that is provided on a vehicle lower part; and
a plurality of reinforcement members that are provided on the panel and extend in a vehicle forward-rearward direction,
wherein the plurality of reinforcement members each has a stiffness change region, and
the stiffness change region of a first reinforcement member that constitutes one of the plurality of reinforcement members is provided at a different position in a longitudinal direction from the stiffness change region of a second reinforcement member that constitutes one of the plurality of reinforcement members.

2. The vehicle body structure according to claim 1,
wherein a fragile portion formed in an entire region in a vehicle width direction of the panel is provided on the panel.

3. The vehicle body structure according to claim 2,
wherein a plurality of fragile portions each being the fragile portion are provided in the vehicle forward-rearward direction.

4. The vehicle body structure according to claim 1,
wherein the plurality of reinforcement members are provided symmetrically in a rightward-leftward direction with reference to a middle in the vehicle width direction.

5. The vehicle body structure according to claim 4,
wherein a number of the plurality of reinforcement members is odd.
